(19) United States
(12) Patent Application Publication
(10) Pub. No.: US 2026/0235775 A1
(43) Pub. Date: Aug. 13, 2026

(54) SYSTEM AND METHOD FOR PRECISION LASER-AIDED NAVIGATION FOR AIR, SPACE AND GROUND VEHICLES IN DEGRADED/DENIED GPS OR IN DEGRADED/LOW VISIBILITY ENVIRONMENTS

(71) Applicant: RD2, LLC, Manassas, VA (US)

(72) Inventors: Priyavadan MAMIDIPUDI, Great Falls, VA (US); Elizabeth A. DAKIN, Jackson, WY (US); Daniel C. DAKIN, Jackson, WY (US); Philip L. ROGERS, Jackson, WY (US); Alisa K. ROGERS, Jackson, WY (US)

(21) Appl. No.: 19/532,223

(22) Filed: Feb. 6, 2026

Related U.S. Application Data
(60) Provisional application No. 63/755,450, filed on Feb. 7, 2025.

(51) Int. Cl. G01S 19/48; G01S 17/58; G01S 17/89; G01S 19/49

(52) U.S. Cl. CPC G01S 19/485; G01S 17/58; G01S 17/89; G01S 19/49

(57) ABSTRACT

A precision laser-aided navigation sensor including a coherent laser Doppler Velocimeter (LDV) coupled with an inertial measurement unit and a vehicle navigation control (VNC) algorithm. The VNC takes real-time inputs of line of sight distance and velocity information from the LDV along one or multiple simultaneous or sequential optical paths distributed around the vehicle along with real-time inertial data (heading) to generate real-time position and track information of the vehicle relative to the terrain or other vehicles within the field of view of the sensor. This raw data can be reported to a higher level control algorithm operating on the vehicle. Alternately, the VNC uses the raw relative position and track data in a feedback control loop to recommend a new speed and 2-D or 3-D steering angle of the vehicle to constantly create an updated “look-ahead point” to efficiently avoid obstacles and direct the vehicle towards the desired location.

### CROSS REFERENCE TO RELATED APPLICATIONS

This non-provisional application claims the benefit under 35 U.S.C. §119(e) of Application Serial No. 63/755,450 filed on February 7, 2025 entitled SYSTEM AND METHOD FOR PRECISION LASER-AIDED NAVIGATION FOR AIR, SPACE AND GROUND VEHICLES IN DEGRADED/DENIED GPS OR IN DEGRADED/LOW VISIBILITY ENVIRONMENTS and whose entire disclosure is incorporated by reference herein.

### BACKGROUND OF THE INVENTION

This present invention relates to navigation systems, and more particularly, to a system and method for precision laser-aided navigation of air, space and ground vehicles in the absence of GPS or degraded GPS and in low or degraded visibility environments.

Travel in the 21st century has become completely reliant on a global positioning system (GPS) to navigate between two locations. There are however parts of the world where GPS signals are degraded or due to terrain or limitation of satellite coverage. There also exists the ability for bad actors to interrupt, deny, or spoof GPS signals which can result in vehicles, aircraft, and/ or ships to be misdirected and end up in potentially dangerous situations. This is especially true for aircraft operating in both civil and military domains. In certain environments, GPS can also have issues with losing accuracy near the ground because of multipath effects, where signals bounce off nearby objects like trees, buildings, or complex terrain features causing GPS receivers on the vehicle to get conflicting information.

Spacecraft traveling to the Moon or Mars do not have the benefit of GPS signals to guide their descent and landing. The lunar surface as well as the Martian surface has regolith that can completely obscure visibility near the terrain during descent and landing operations.

With autonomous driving becoming more and more integrated into vehicles, precise and instantaneous knowledge of vehicle position and velocity relative to other surrounding vehicles is critical to ensure safe operations. This is currently being addressed using high speed cameras that compare before and after images coupled with GPS as well as radar and lidar sensors that compute distance and then attempt to derive the relative velocity of vehicles to determine safe stopping distance, braking algorithms, go/ no-go decisions, etc. GPS degraded/ denied conditions as well as low visibility/ bad weather conditions such as snow, dust, and fog can degrade the position accuracy of these vehicles in real-time leading to lack of operation of these vehicles under certain conditions, or accidents.

As a result, safe, uninterrupted operation of ground vehicles, air vehicles, as well as spacecraft in environments where external location and navigation signals are degraded or denied has become a necessity in both civil and military domains. Unmanned Aerial Vehicles (UAVs), drones, air taxis, helicopters, as well as aircraft, both civil and military, encounter situations where GPS signals are degraded (or denied). They can further encounter situations where visibility to the ground is significantly reduced, such as nighttime operations, dust, fog, or other such conditions.

Thus, in view of the foregoing, there remains a need for a more reliable self-sufficient system for navigating in these different environments. The present invention solves these problems.

All references cited herein are incorporated herein by reference in their entireties.

### BRIEF SUMMARY OF THE INVENTION

A navigation system for a vehicle (e.g., air vehicle, space vehicle, ground vehicle, etc.), having an inertial measurement unit, (IMU), that can navigate in the absence of, or in a degraded mode, of a global positioning system (GPS) is disclosed. The vehicle navigation system comprises: a laser doppler velocimeter (LDV) associated with the vehicle that measures real-time line of sight (LOS) range and LOS velocity, forming inputs, along multiple simultaneous laser paths below or ahead of the LDV and generates a distance, an attitude and a three-dimensional relative velocity map ahead of the vehicle. And wherein the LDV further comprises a vehicle navigation control (VNC) algorithm that takes the real-time inputs from the multiple simultaneous inputs, along with real time inertial data and generates real time position and track information of the vehicle relative to a terrain or other vehicles within a field of view of said LDV, wherein the real time position and track information of the vehicle are used by the vehicle navigation system in a feedback control loop to recommend a new speed and 2-D or 3-D steering angle of the vehicle to constantly create an updated “look-ahead point” to efficiently avoid obstacles and direct the vehicle towards a desired location, all in the absence of GPS or in degraded mode of the GPS.

A navigation system for a vehicle (e.g., air vehicle, space vehicle, ground vehicle, etc.), having an inertial measurement unit, (IMU), that can navigate in the absence of, or in a degraded mode, of a global positioning system (GPS) is disclosed. The vehicle navigation system comprises: a laser doppler velocimeter (LDV) associated with the vehicle that measures real-time line of sight (LOS) range and LOS velocity, along multiple simultaneous laser paths below or ahead of the LDV and generates a distance, an attitude and a three-dimensional relative velocity map ahead of the vehicle, wherein the distance, attitude and the three dimensional relative velocity map ahead of the vehicle, forming raw data, being provided to an existing vehicle control system that uses the raw data to control the vehicle, all in the absence of GPS or in degraded mode of the GPS.

A method of forming a navigation system for a vehicle (e.g., air vehicle, space vehicle, ground vehicle, etc.), having an inertial measurement unit, (IMU), that can navigate in the absence of, or in a degraded mode, of a global positioning system (GPS) is disclosed. The method comprises: associating a laser doppler velocimeter (LDV) with the vehicle that measures real-time line of sight (LOS) range and LOS velocity, forming inputs, along multiple simultaneous laser paths below or ahead of the LDV; generating, by the LDV, a distance, an attitude and a three-dimensional relative velocity map ahead of the vehicle; feeding the real-time inputs from the multiple simultaneous inputs, along with real time inertial data to a vehicle navigation control (VNC) algorithm; generating, by the VNC algorithm, real time position and track information of the vehicle relative to a terrain or other vehicles within a field of view of the LDV; and forming a feedback control loop in the vehicle navigation system for using the real time position and track information of the vehicle to recommend a new speed and 2-D or 3-D steering angle of the vehicle for constantly creating an updated “look-ahead point” to efficiently avoid obstacles and direct the vehicle towards a desired location, all in the absence of GPS or in degraded mode of the GPS.

A method of forming navigation system for a vehicle (e.g., air vehicle, space vehicle, ground vehicle, etc., having an inertial measurement unit, (IMU), that can navigate in the absence of, or in a degraded mode, of a global positioning system (GPS) is disclosed. The method comprises: associating a laser doppler velocimeter (LDV) with the vehicle that measures real-time line of sight (LOS) range and LOS velocity along multiple simultaneous laser paths below or ahead of the LDV; generating, by the LDV, a distance, an attitude and a three-dimensional relative velocity map ahead of the vehicle, forming raw data; and feeding the raw data to an existing vehicle control system that uses said raw data to control the vehicle, all in the absence of GPS or in degraded mode of the GPS.

### BRIEF DESCRIPTION OF SEVERAL VIEWS OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a system diagram of the present invention which uses a laser doppler velocimeter (LDV) for providing critical navigation data, either in raw form or in a processed format, that the vehicle’s navigation system uses to course correct.

### DETAILED DESCRIPTION OF THE PREFERRED EMBODIMENTS

Referring now to the figures, wherein like reference numerals represent like parts throughout the several views, exemplary embodiments of the present disclosure will be described in detail. Throughout this description, various components may be identified having specific values, these values are provided as exemplary embodiments and should not be limiting of various concepts of the present invention as many comparable sizes and/or values may be implemented.

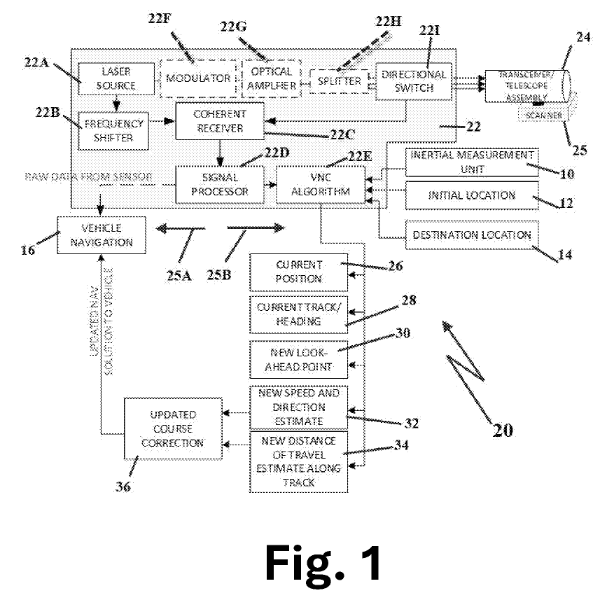

As shown in FIG. 1, the system and method 20 of the present invention uses Laser Doppler Velocimetry (LDV) -based navigation as an alternative to GPS navigation. As such, LDV-based navigation is a standalone, high reliability, high precision solution located within each vehicle that eliminates reliance on external sources (like GPS from satellites) and operates in all weather and visibility conditions (such as rain, dust, fog) without any degradation in performance.

This precision laser-aided navigation sensor comprises a coherent laser Doppler Velocimeter (LDV) 22 coupled with an inertial measurement unit (IMU) 10 and a vehicle navigation control (VNC) algorithm 22E. The LDV sensor 22 measures real-time line of sight range and line of sight velocity along multiple simultaneous laser paths below (or ahead) the sensor to create a distance, attitude, and 3-dimensional relative velocity map ahead of the sensor platform. The VNC algorithm 24 takes real-time inputs of line of sight distance and velocity information from the LDV 22 along one or multiple simultaneous or sequential optical paths distributed around the vehicle (not shown) along with real-time inertial data (e.g., heading) to generate real-time position and track information of the vehicle relative to the terrain or other vehicles within the field of view of the sensor 22. This raw data can be reported to a higher level control algorithm operating on the vehicle, as indicated by path 25A. Alternately, the VNC uses the raw relative position and track data in a feedback control loop to recommend a new speed and 2-D or 3-D steering angle of the vehicle to constantly create an updated “look-ahead point” to efficiently avoid obstacles and direct the vehicle towards the desired location, as shown in path 25B.

The Laser Doppler Velocimeter (LDV sensor 22) comprises:

a solid state, fiber-based, or photonic integrated circuit based laser source 22A operating in near-infrared wavelengths (such as 1550 nm), operated either in continuous wave;

a frequency shifter 22B capable of taking a small percentage of the continuous wave laser signal to create a frequency shifted reference signal;

a modulator 22F capable of generating laser pulses from the continuous wave laser source, if operated in pulsed mode;

an optical amplifier 22G (such as a fiber amplifier), as required, capable of amplifying the continuous wave or pulsed laser signal from the laser source 22A to high powers;

an optical splitter 22H capable of splitting the laser signals into multiple independent laser beams, as required;

directional optical switch 22I, such as an optical circulator, to direct the transmitter laser light forward towards a transceiver telescope assembly 24, and to direct the return laser light from the transceiver telescope assembly 24 towards a coherent receiver 22C;

the transceiver telescope assembly 24 is capable of expanding the laser beam and transmitting the laser signal towards the target, and receiving backscattered laser signals from the target of interest for each laser beam:

a first embodiment of this would be that a single transceiver telescope assembly 24 is capable of simultaneously or sequentially transmitting and receiving laser pulses along multiple non-collinear optical paths; or second embodiment would be where the transceiver telescope assembly 24 is integrated with a scanning system 25 to create a three-dimensional moving high density point cloud for real-time relative spatial awareness;

an optoelectronic receiver (or receivers) 22C capable of measuring laser signals collected by the receiver telescope optical assembly and independently combining said laser signals with a percentage of the transmitter laser signal from the corresponding transmitter laser, and converting the mixed optical signals into electrical signals;

digitization electronics capable of measuring said return signals along each of the receiver channels;

signal processing algorithms 22D capable of analyzing received signals to determine line-of-sight distance (LOS) and/ or line of sight velocity along each beam, with the option of combining the measured line of sight distance and/ or velocity measurements with measurements from a platform orientation sensor (such as an Inertial Measurement Unit 10) to measure range (altitude) and 3-dimensional velocity of the platform relative to the target surface;

the ability to report line of sight range and velocity data along each of the laser beams to the vehicle navigation system 16, if desired;

with LOS distance accuracies of better than 6” over the entire measurement range;

with LOS velocity with accuracies of better than 0.05 m/s over the entire measurement range;

capable of providing real-time line of sight distance and line of sight velocity measurements at high data rates of as much as 100 Hz required for automatic control systems;

a Vehicle Navigation Control (VNC) algorithm 22E capable of taking, at least, real-time line of sight range and velocity inputs from the LDV sensor 22, 3-dimensional pointing information from the scanner 25 (if applicable), pitch, roll, yaw, and acceleration data from the Inertial Measurement Unit 10, current location, as well as destination location from the Vehicle’s navigation system (or user input);

the Vehicle Navigation Control (VNC) algorithm 24 capable of computing in real-time and reporting, as a minimum, current position 26, current range, current velocity over terrain (speed and ground track) 28, as well as an updated look-ahead point 30, new speed and direction estimate 32 to course correct towards the destination location, as well as new distance estimate and time to travel based on estimate along new track 34;

the Vehicle Navigation Control (VNC) algorithm capable of reporting some or all of these computed values to the Vehicle Navigation system 16 on the vehicle as well as the ability to display some or all of the navigation parameters on a user display, if desired;

ability to communicate real-time data in wired arrangement to the vehicle or in a wireless manner to other control systems; and

ability to integrate with a Laser Doppler Velocimetry based wind sensor (not shown, or any form of wind sensor) to provide complete 3-dimensional situational awareness for an air vehicle.

Applicant incorporates by reference the following patents, all of which are assigned to the same assignee as the assignee of the present application, namely, RD2, LLC: U.S. Patent Nos. 8,508722 (Rogers, et al.); 8,879,051 (Rogers, et al.); 8,930,049 (Rogers, et al.); and 8,961,181 (Rogers, et al.).

While the invention has been described in detail and with reference to specific examples thereof, it will be apparent to one skilled in the art that various changes and modifications can be made therein without departing from the spirit and scope thereof.

What is claimed is:

1. A navigation system for a vehicle, having an inertial measurement unit, (IMU), that can navigate in the absence of, or in a degraded mode, of a global positioning system (GPS), said vehicle navigation system comprising:
a laser doppler velocimeter (LDV) associated with the vehicle that measures real-time line of sight (LOS) range and LOS velocity, forming inputs, along multiple simultaneous laser paths below or ahead of said LDV and generates a distance, an attitude and a three-dimensional relative velocity map ahead of the vehicle, said LDV further comprising a vehicle navigation control (VNC) algorithm that takes said real-time inputs from said multiple simultaneous inputs, along with real time inertial data and generates real time position and track information of the vehicle relative to a terrain or other vehicles within a field of view of said LDV, said real time position and track information of the vehicle being used by the vehicle navigation system in a feedback control loop to recommend a new speed and 2-D or 3-D steering angle of the vehicle to constantly create an updated “look-ahead point” to efficiently avoid obstacles and direct the vehicle towards a desired location, all in the absence of GPS or in degraded mode of the GPS.

2. The vehicle navigation system of claim 1 wherein said inertial data includes initial location data.

3. The vehicle navigation system of claim 1 wherein said LDV comprises a single transceiver telescope assembly capable of simultaneously or sequentially transmitting and receiving laser pulses along multiple non-collinear paths.

4. The vehicle navigation system of claim 1 wherein said LDV comprises a transceiver telescope assembly that is integrated with a scanning system for creating a three-dimensional moving high density point cloud for real-time relative spatial awareness.

5. A navigation system for a vehicle, having an inertial measurement unit, (IMU), that can navigate in the absence of, or in a degraded mode, of a global positioning system (GPS), said vehicle navigation system comprising:
a laser doppler velocimeter (LDV) associated with the vehicle that measures real-time line of sight (LOS) range and LOS velocity along multiple simultaneous laser paths below or ahead of said LDV and generates a distance, an attitude and a three-dimensional relative velocity map ahead of the vehicle, said distance, attitude and said three dimensional relative velocity map ahead of the vehicle, forming raw data, being provided to an existing vehicle control system that uses said raw data to control the vehicle, all in the absence of GPS or in degraded mode of the GPS.

6. The vehicle navigation system of claim 1 wherein said existing vehicle control system receives initial location data and destination location data.

7. The vehicle navigation system of claim 5 wherein said LDV comprises a single transceiver telescope assembly capable of simultaneously or sequentially transmitting and receiving laser pulses along multiple non-collinear paths.

8. The vehicle navigation system of claim 5 wherein said LDV comprises a transceiver telescope assembly that is integrated with a scanning system for creating a three-dimensional moving high density point cloud for real-time relative spatial awareness.

9. A method of forming navigation system for a vehicle, having an inertial measurement unit, (IMU), that can navigate in the absence of, or in a degraded mode, of a global positioning system (GPS), said method comprising:
associating a laser doppler velocimeter (LDV) with the vehicle that measures real-time line of sight (LOS) range and LOS velocity, forming inputs, along multiple simultaneous laser paths below or ahead of said LDV;
generating, by said LDV, a distance, an attitude and a three-dimensional relative velocity map ahead of the vehicle;
feeding said real-time inputs from said multiple simultaneous inputs, along with real time inertial data to a vehicle navigation control (VNC) algorithm;
generating, by said VNC algorithm, real time position and track information of the vehicle relative to a terrain or other vehicles within a field of view of said LDV; and
forming a feedback control loop in said vehicle navigation system for using said real time position and track information of the vehicle to recommend a new speed and 2-D or 3-D steering angle of the vehicle for constantly creating an updated “look-ahead point” to efficiently avoid obstacles and direct the vehicle towards a desired location, all in the absence of GPS or in degraded mode of the GPS.

10. The method of claim 9 wherein said step of associating the LDV with the vehicle comprises using a single transceiver telescope assembly that is capable of simultaneously or sequentially transmitting and receiving laser pulses along multiple non-collinear paths.

11. The method of claim 9 wherein said step of associating the LDV with the vehicle comprises LDV comprises using a transceiver telescope assembly that is integrated with a scanning system for creating a three-dimensional moving high density point cloud for real-time relative spatial awareness.

12. A method of forming navigation system for a vehicle, having an inertial measurement unit, (IMU), that can navigate in the absence of, or in a degraded mode, of a global positioning system (GPS), said method comprising:
associating a laser doppler velocimeter (LDV) with the vehicle that measures real-time line of sight (LOS) range and LOS velocity along multiple simultaneous laser paths below or ahead of said LDV;
generating, by said LDV, a distance, an attitude and a three-dimensional relative velocity map ahead of the vehicle, forming raw data; and
feeding said raw data to an existing vehicle control system that uses said raw data to control the vehicle, all in the absence of GPS or in degraded mode of the GPS.

13. The method of claim 12 wherein said step of feed raw data to the existing vehicle control system comprises also feeding initial location data and destination location data to said existing vehicle control system.

14. The method of claim 12 wherein said step of associating said LDV with the vehicle comprises using a single transceiver telescope assembly capable of simultaneously or sequentially transmitting and receiving laser pulses along multiple non-collinear paths.

15. The method of claim 12 wherein said step of associating said LDV with the vehicle comprises using a transceiver telescope assembly that is integrated with a scanning system for creating a three-dimensional moving high density point cloud for real-time relative spatial awareness.
